(19) United States
(12) Patent Application Publication
(10) Pub. No.: US 2024/0130030 A1
(43) Pub. Date: Apr. 18, 2024

(54) METHODS FOR MIXING FLUIDS FOR A PLASMA CUTTING TORCH

(71) Applicant: ESAB AB, Gothenburg (SE)

(72) Inventor: Erik Anthony Leger, Peterborough, NH (US)

(21) Appl. No.: 17/967,486

(22) Filed: Oct. 17, 2022

(51) Int. Cl. H05H 1/34; H05H 1/36

(52) U.S. Cl. CPC H05H 1/3494; H05H 1/3421; H05H 1/3478; H05H 1/36; B23K 10/006

(57) ABSTRACT

A method, apparatus, and computer program product are provided for operating a plasma cutting torch. A plasma cutting torch tip is provided at a distance from a workpiece to initiate a piercing or cutting operation. A supply of a first fluid and a second fluid is provided to a valve upstream of the plasma cutting torch tip, wherein the valve is joined to the plasma cutting torch tip by a fluid line. During the piercing or cutting operation, the valve is switched according to a first pattern to provide a mixture of the first fluid and the second fluid to the plasma cutting torch tip.

### TECHNICAL FIELD

The present disclosure relates to methods for mixing fluids that are supplied to a plasma cutting torch.

### BACKGROUND

A plasma cutting torch often requires mixtures of fluids at particular ratios when performing plasma cutting. Fluid mixing can be extremely expensive, typically requiring precise monitoring of multiple variables to properly and absolutely characterize a real-time mixing operation. Thus, conventional approaches to plasma cutting often require a pre-mixed supply of fluids for certain operations to avoid detrimental results. For example, a mixture of oxygen in a shield gas during a piercing of thick mild steel causes an exothermic reaction which decreases the pierce time. Conventional plasma cutting approaches cannot provide these mixtures on-site, as such techniques are too expensive of a function to integrate using conventional absolute mass flow methods. Accordingly, a method of producing mixtures of fluids on-demand is desired.

### SUMMARY

Techniques for piercing and cutting a metal workpiece are disclosed. These techniques may be embodied as one or more methods, an apparatus, a system, and/or non-transitory computer readable storage media.

In accordance with at least one embodiment, the present application is directed to a method, apparatus, and computer program product for plasma piercing a workpiece using a plasma cutting torch. According to one implementation the method includes providing a plasma cutting torch tip at a distance from a workpiece to initiate a piercing or cutting operation, providing a supply of a first fluid and a second fluid to a valve upstream of the plasma cutting torch tip, wherein the valve is joined to the plasma cutting torch tip by a fluid line, and during the piercing or cutting operation, switching the valve according to a first pattern to provide a mixture of the first fluid and the second fluid to the plasma cutting torch tip.

By switching the valve according to a particular pattern to permit both the first fluid and second fluid into a fluid line downstream of the valve, present embodiments enable the fluids to mix at a ratio that is approximately based on the timing of the pattern at which the valve is switched. Accordingly, present embodiments achieve mixing of fluids at any desired ratio in a manner that is more economical and can be performed on-site and on-demand.

In some embodiments, the mixture is provided based on one or more of: a length of the fluid line, a path of the fluid line, and an interior friction parameter of the fluid line. One or more of these parameters can be adjusted in order to ensure that the fluids can achieve a substantially homogeneous mixture while accommodating other design concerns, such as the distance and/or route from the valve to the torch tip, materials used in the fluid line, and the like.

In some embodiments, an additional one or more fluids are provided to the valve, and wherein switching the valve according to the pattern further includes providing a mixture of the first fluid, the second fluid, and the additional one or more fluids to the plasma cutting torch tip. Thus, mixtures that include more than two fluids can be achieved, thereby extending the utility of present embodiments to additional plasma piercing or cutting operations.

In some embodiments, the first fluid or the second fluid is selected from a group of: a cutting fluid, a shield fluid, water, and oxygen. Accordingly, fluids that are utilized in piercing, cutting, and/or shielding can be mixed with other fluids, such as water or oxygen (or other fluids), to achieve desired results.

In some embodiments, the first pattern includes a periodicity of one second or less. Thus, the valve can be rapidly actuated in a manner that constantly provides different fluids to a line, whereupon the fluids are able to achieve a homogeneous mixture while traveling through the line.

In some embodiments, a second pattern is employed during the piercing or cutting operation, wherein the valve is switched differently according to the second pattern than according to the first pattern. Thus, different patterns can be utilized throughout an operation, thereby enabling different ratios of fluids and/or different combinations of fluids in the resulting mixtures, to be achieved to achieve any desired plasma cutting results.

In some embodiments, a pilot pressure regulator is provided between the valve and an outlet of the plasma cutting torch tip to reduce an influence of pulsation pressure effects on the piercing or cutting operation. The pilot pressure regulator thus reduces or substantially eliminates pressure surges, shockwaves, or other undesired side-effects of rapidly switching a valve.

In some embodiments, the valve is selected from a group of: a two-port, two-position valve, a three-port, two-position valve, a four-port, three-position valve, and a shuttle valve. Accordingly, various numbers of fluids can be joined at a valve and/or flow away from a valve.

In some embodiments, the valve is electrically-actuated. Electrical actuation can achieve a reliable and fast switching of the valve that can more easily be controlled by an electronic controller, such as a computer.

These and other advantages and features will become evident in view of the drawings and detailed description.

### BRIEF DESCRIPTION OF THE DRAWINGS

FIG. 1A is a perspective view of an automated cutting system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch.

FIG. 2A is a schematic depicting a gas system for a plasma cutting system/torch, according to an example embodiment.

FIG. 2B is a schematic depicting a gas system for a plasma cutting system/torch, according to another example embodiment.

FIG. 3 is a flow chart depicting a method of operating a plasma cutting torch and/or a plasma torch gas system, according to an example embodiment.

FIG. 4 is a graph showing variations in valve parameters over time during a piercing or cutting operation.

FIG. 5 is a block diagram depicting a computing device for controlling a plasma torch in accordance with an example embodiment.

### DETAILED DESCRIPTION

The following description is not to be taken in a limiting sense but is given solely for the purpose of describing the broad principles of the present application. Embodiments of the present application will be described by way of example, with reference to the above-mentioned drawings showing elements and results of such embodiments.

Generally, with the techniques presented herein, a plasma cutting torch is provided with any desired mixture of fluids on-demand and on-site by pulse width modulating a selection valve at a particular frequency. The valve, which is provided with two or more input fluids, is rapidly modulated (e.g., on the order of seconds or milliseconds), causing multiple fluids to be introduced into a line leading from the valve to the torch. While the fluids travel the length of the line from the valve to the torch, the fluids are able to mix to achieve a substantially homogeneous mixture. In particular, turbulent flow caused by the interior friction of the line and changes in momentum of the fluids cause the mixing, and the length of the line ensures that there is ample time for the fluids to achieve substantial homogeneity prior to arriving at the torch end.

Accordingly, present embodiments provide an inexpensive, novel solution to fluid mixing for plasma cutting applications by performing mixing at any valve which has the ability to stop or start fluid flow in a plasma cutting system. By timing the duty cycle modulation according to a particular sample frequency, the valve can mix fluids to achieve a desired ratio. For example, if a three-to-one mixture of two gasses is desired, the duty cycle of each control valve at an equal sampling frequency can be empirically determined to yield such a mixture. In other words, a relationship between the relative duty cycle and mass flow proportion of the mixture can be empirically determined given knowledge of component gas supply pressures (regulated to a known value), temperatures (assumed ambient), and standard gas densities. Thus, expensive mass flow sensors and flow controllers are rendered unnecessary, and further, there is no need to integrate temperature and pressure sensors alongside mass flow sensors, which would otherwise be necessary to account for variances in the density of fluids. Given the empirical nature of the relationship, each unique combination of process gasses would have their own associated duty cycle vs mass flow proportion regressions, and given a predetermined and precalibrated supply pressure requirement for all components, and assumption of ambient and equal temperature, only identification of component gasses is necessary to calculate a combination of relative duty cycles which will yield the target proportional gas mixture. Additionally, unlike conventional manual mixing techniques, which require an amount of labor that negates any cost savings, present embodiments provide an automated approach to mixing that is software-controllable by a computing device.

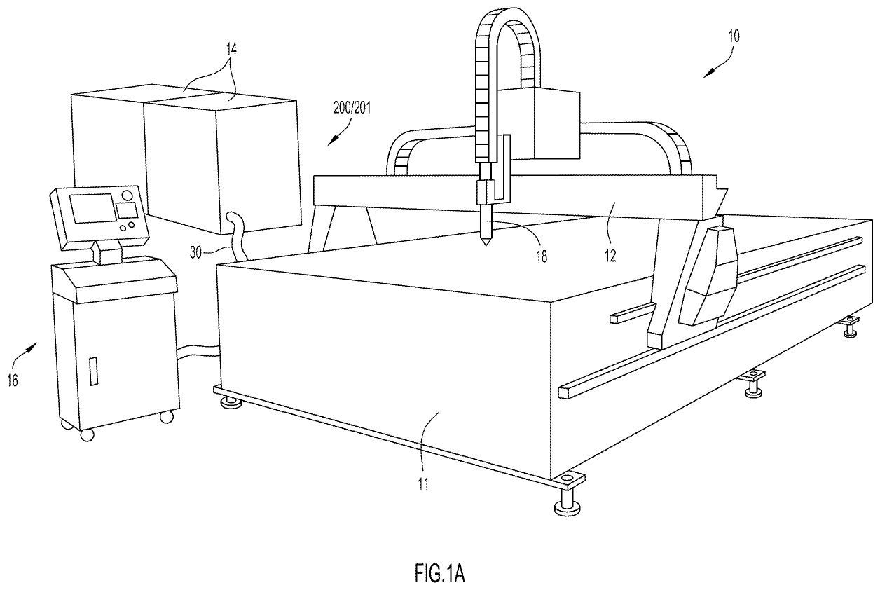

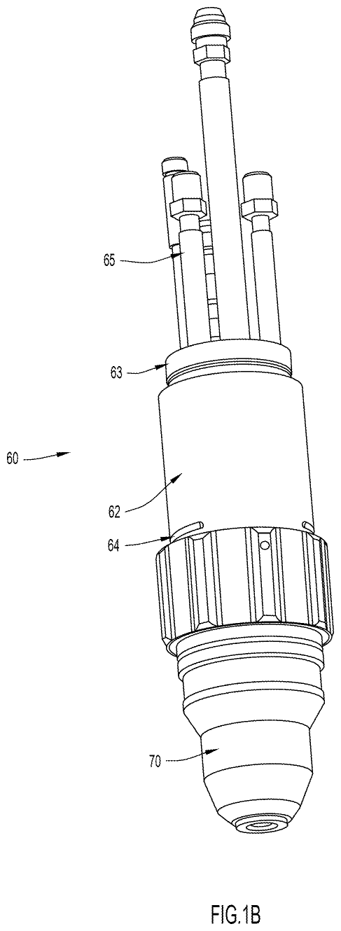

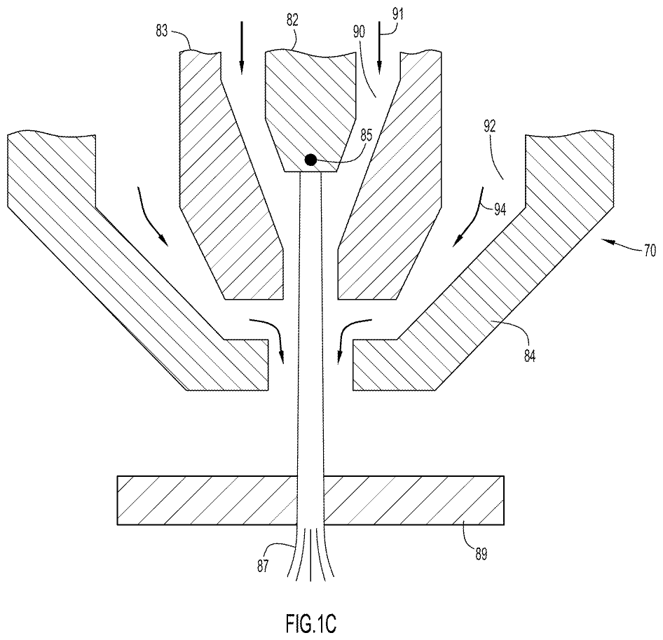

FIG. 1A illustrates an example embodiment of an automated cutting system 10 that may execute the techniques presented herein. However, this automated cutting system 10 is merely presented by way of example and the techniques presented herein may also be executed by manual cutting systems and/or automated cutting systems that differ from the automated cutting system 10 of FIG. 1A (e.g., any robotic or partially robotic cutting system). That is, the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Finally, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14. The controller 16 and power supply 14 may be fluidly and/or electrically connected to each other, the positioning system 12, and/or the plasma arc torch 18 via one or more conduits, leads, or cables 30.

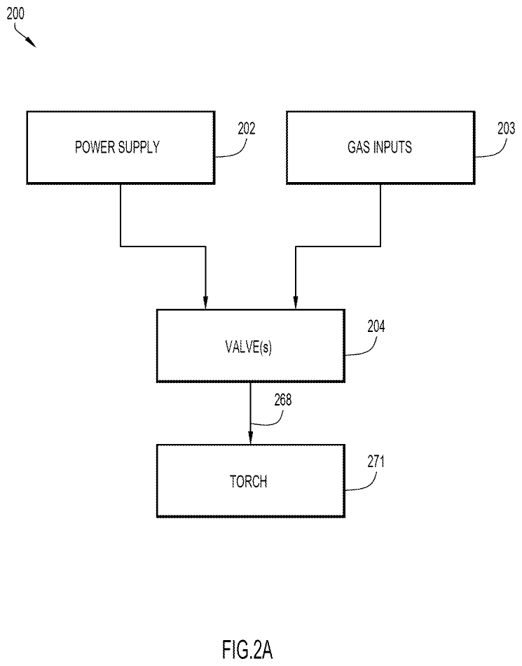

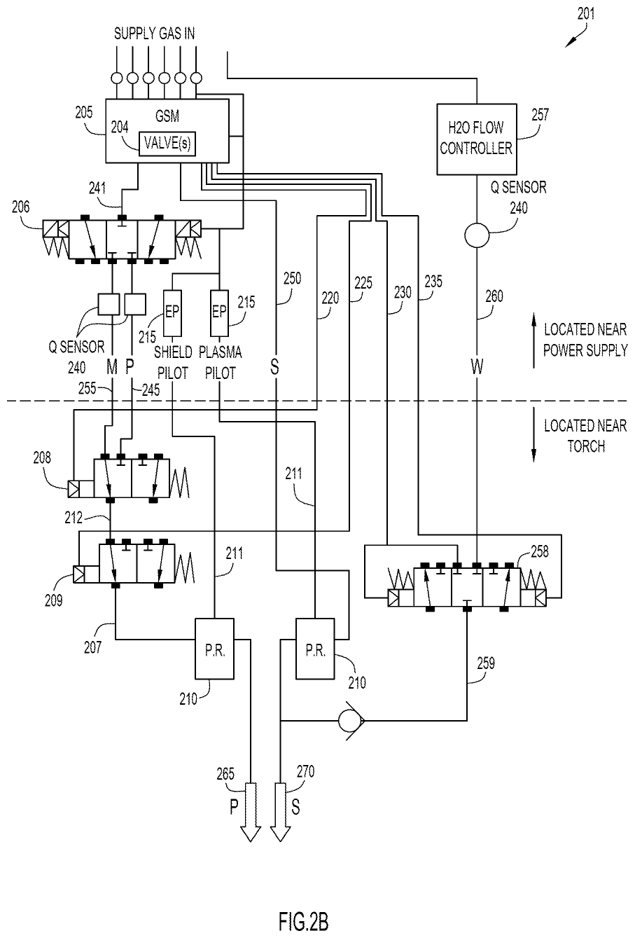

A gas control system 200/201 controls the one or more flows of fluid to the automated plasma arc torch 18. The gas control system 200/201 may include one or more cables 30, and one or more processors disposed in the controller 16 and/or the one or more power supplies 14. In some implementations, the system 200/201 may further include a regulator (e.g., an electro-pneumatic regulator), a valve, a pilot regulator, and the torch 18. In some instances, one or more of the valve and the pilot regulator may be disposed in the torch 18, and the regulator may be disposed in the one or more power supplies 14 and/or the controller 16. System 200 is discussed in further detail below with reference to FIG. 2A, and another embodiment that includes a gas control system 201 is discussed in further detail below with reference to FIG. 2B.

In at least some embodiments, the one or more power supplies 14 meter one or more flows of fluid received from one or more fluid supplies before or as the one or more power supplies 14 supply gas to the torch 18 via one or more cable conduits 30 (e.g., of gas control system 200/201). Additionally or alternatively, the automated cutting system 10 may include a separate fluid supply unit (not shown) or units that can provide one or more fluids to the automated torch 18 independent of the one or more power supplies 14 (e.g., via gas control system 200/201). To be clear, as used herein, the term “fluid” shall be construed to include a gas or a liquid. The one or more power supplies 14 may also condition, meter, and supply power to the automated torch 18 via one or more cables, which may be bundled with, integrated with, or provided separately from cable conduits 30 for fluid flows (e.g., of gas control system 200/201). Additional cables for data, signals, and the like may also interconnect the controller 16, the automated plasma arc torch 18, the power supply 14, and/or the positioning system 12. Any cable or cable conduit/hose 30 included in the automated cutting system 10 (e.g., in the gas control system 200/201) may be any length. Moreover, each end of any cable or cable conduit/hose 30 may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 to connect to the torch body 62 in detail. However, it should be understood that the cutting consumables, such as those schematically illustrated in FIG. 1C, may be coupled to a torch body 62 in any manner. Moreover, to be clear, the consumable stack 70 depicted in FIGS. 1B and 1C (with an external perspective view and a schematic cross-sectional illustration, respectively) is merely representative of a consumable stack that may be used with an automated torch executing the techniques presented herein. Similarly, while none of the Figures of the present application illustrate an interior of torch body 62, it is to be understood that any unillustrated components that are typically included in a torch, such as components that facilitate cutting operations, may (and, in fact, should) be included in a torch executing example embodiments of the present application.

Now turning to FIG. 1C, this Figure is a simplified/schematic illustration of the consumable stack 70 of FIG. 1B. As mentioned, FIG. 1C only illustrates select components or parts that allow for a clear and concise illustration of the techniques presented herein. Thus, in FIG. 1C, only an electrode 82, a nozzle 83, and a shield cap 84 of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The torch nozzle 83 is generally positioned around the electrode 82. In some embodiments the nozzle 83 is installed after the electrode 82. Alternatively, the electrode 82 and nozzle 83 can be installed onto the torch body as a single component (e.g., these components may be coupled to each other to form a cartridge and installed on/in the torch body as a cartridge). In either case, the nozzle 83 may be spaced from the electrode 82, or at least a distal portion of the nozzle 83 may be spaced apart from the distal portion of the electrode 82.

The shield 84 is positioned radially exteriorly of the nozzle 83 and is spaced apart from the nozzle, at least at its distal end. In some embodiments, the shield 84 is installed around an installation flange of the nozzle 83 in order to secure nozzle 83 and electrode 82 in place at (and in axial alignment with) an operating end of the torch body. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap, etc.) may be assembled together in a cartridge that may be selectively coupled to the torch body, e.g., by coupling the various components to a cartridge body and/or by coupling the various components to each other to form a cartridge.

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 flows through the plasma gas flow channel 90. The shield 84 is also spaced a distance away from the nozzle 83 so that a shield flow channel 92 is disposed between the shield 84 and the nozzle 83, A shield fluid 94 flows through the shield flow channel 92 during at least a portion of the time the torch is operated.

While FIG. 1C provides one schematic view of torch consumables that can execute the techniques presented herein, for completeness, it should be understood that U.S. Pat. No. 9,131,596 discloses a plasma torch that is also usable in carrying out the processes disclosed herein, and is incorporated herein by reference in its entirety.

FIG. 2A is a schematic depicting a gas system 200 for a plasma cutting system/torch, according to an example embodiment. As depicted, gas system 200 includes a power supply 202, gas inputs 203, one or more valves 204, and a torch 271. Power supply 202 provides electricity to the one or more valves 204 in order to actuate the one or more valves 204. In various embodiments, any of the one or more valves 204 may be electromagnetically-actuated or electro-pneumatically-actuated. Still, in some embodiments, one or more valves 204 may be fully pneumatically-actuated.

Gas inputs 203 may include one or more gas lines that provide gases to the one or more valves 204 so that the gases can be mixed in accordance with the techniques presented herein. In particular, the one or more valves 204 can be actuated according to a desired pattern to achieve an approximately ratiometric mixing of the input gases that are permitted passage by the particular valve positions occupied when the one or more valves are actuated. That is, the valve 204 may be operated pursuant to one or more duty cycles to achieve, in essence, pulse width modulation mixing of multiple gasses. The one or more valves output to a common line 268 in which gases are permitted to mix, thereby substantially achieving a homogeneous mixture by the time that the gases arrive at torch 271. The length of the line 268 may be selected, at least in part, based on a frequency of valve switching, with higher frequency switching requiring less length and lower frequency switching. The mixed gases may be used for a variety of purposes at torch 271, such as cutting, shielding, and the like.

FIG. 2B is a schematic depicting a gas system 201 for a plasma cutting system/torch, according to an example embodiment. Gas system 201 may correspond to the embodiment depicted and described in FIG. 1A or may represent another embodiment. This gas system 201 may execute the techniques presented in the present application; however, to be clear, this is merely an example gas system and any other gas system with the appropriate gas handling equipment (e.g., one or more valves) might also execute the techniques presented herein.

As depicted, gas system 201 includes a gas selection manifold 205, valves 206, 208, 209, and 258, pilot regulators 210, electro-pneumatic regulators 215, pneumatic lines 220, 225, 230, and 235, flow rate sensors 240, fluid lines 245, 250, and 255, water flow controller 257, water line 260, and pathways 265 and 270. Generally, these components are connected in a manner that allows non-electrical control of valves positioned in or proximate to a plasma torch. Most notably, valves 208, 209, and 258 are connected to pneumatic line 220, pneumatic line 225, and the combination of pneumatic lines 230, and 235, respectively, to provide non-electrical control of valves 208, 209, and 258. This may be advantageous because it allows the valves 208, 209, and 258, which are positioned in or proximate to a plasma torch, to be controlled without risk of electromagnetic interference (EMI)—often generated by plasma cutting operations—deteriorating such control. Thus, the mixing techniques can be executed together with a valve system that provides accurate gas control at or adjacent the plasma torch.

Gas selection manifold 205 may include one or more valves whose positions can be rapidly switched to achieve mixing of fluids in accordance with present embodiments. In various embodiments, the valve or valves of gas selection manifold 205 may include a two-port, two-position valve, a three-port, two-position valve, a four-port, three-position valve, a shuttle valve, or other valve. A valve of gas selection manifold 205 may be controlled in a manner such that the position of the valve is changed accordingly to a particular pattern and/or at a particular periodicity. For example, the valve may have a periodicity of one second at a duty cycle of 50%, during which the valve occupies a first position for approximately 500 ms and a second position for 500 ms, after which the valve may return to the first position to repeat the pattern.

One or more fluids may be provided to gas selection manifold 205 via one or more inlets, and may exit via one or more outlets. In the depicted embodiment, gas selection manifold 205 receives inputs which can include one or more fluids suitable for marking, one or more fluids suitable for plasma cutting, one or more fluids suitable for shielding, as well as pneumatic inputs for actuating pneumatically-controllable components of gas system 201. Gas selection manifold 205 may output several pneumatic lines (e.g., pneumatic lines 220, 225, 230, and 235), as well as other fluid lines (e.g., marking line, plasma line, shield line, etc.). Additionally, gas selection manifold 205 may output fluid lines 241 (e.g., a plasma fluid line) and 250 (e.g., a shield fluid line). However, to be clear, the aforementioned inputs and outputs are merely examples and other embodiments may include any number of inputs and outputs.

That said, in the depicted embodiment, the output lines (e.g., fluid lines 241 and 255 and/or pneumatic lines 220, 225, 230, and 235) of gas selection manifold 205 may pass through one or more valves, sensors, and/or pilot regulators before arriving at a subsequent downstream element (e.g., pathways 265 and 270 in the case of non-pneumatic lines, and pneumatically-controllable elements in the case of pneumatic lines). In the depicted embodiment, fluid line 241 first enters valve 206. Valve 206 may split fluid in fluid line 241 into two fluid lines: fluid line 245 (e.g., piercing line 245) and fluid line 255 (e.g., marking line 255) that pass through flow rate sensors 240 to valve 208. Valve 208 may then select fluid from line 245 and/or 255 to pass to valve 209 via a common line 212, which continues traveling to valve 209. Valve 209 may then make a further selection, e.g., to choose cutting fluid from line 245 and/or 255 (e.g., during a torch operation, such as cutting, piercing, or marking), and/or shielding fluid from line 250 (e.g., to purge the torch). The common line 207 exiting from valve 209 travels to pilot regulator 210 and ultimately to plasma pathway 265.

While the aforementioned components handle plasma fluid (e.g., fluid that is ionized during marking, cutting, and/or piercing), fluid line 250 may provide one or more shield fluids for gas system 201. In the depicted embodiment, fluid line 250 initiates at gas selection manifold 205 and splits to provide shielding fluid to valve 209 (as mentioned) and to pilot regulator 210. Fluid line 250 can accordingly provide a fluid that is mixed at valve 209 with another fluid of common line 207 (e.g., pursuant to the mixing techniques presented herein). In fact, valve 209 should be understood to be representative of any valve proximate the torch that may execute the mixing techniques presented herein, e.g., with pneumatic actuations. Because fluid line 250 bifurcates, fluid line 250 can provide a fluid to either or both of pathways 265 and 270 (e.g., for purging the torch head).

Pneumatic lines 220, 225, 230, and 235 enable components of gas system 201 to be actuated via air or other fluids, which can be selectively provided down pneumatic lines 220, 225, 230, and/or 235 to act as signals to the pneumatically-controllable components. In the depicted embodiment, pneumatic line 220 controls marking components (e.g., valve 208) while pneumatic line 225 controls preflow and/or water purge components (e.g., valve 209) and pneumatic lines 230 and 235 control water mist secondary components. As mentioned, by controlling components that are closer to the plasma cutting torch end with pneumatic lines, electrical controls are avoided, which would otherwise be subject to interference (e.g., via induced currents) during cutting operations. It should be appreciated that pneumatic lines 220, 225, 230, and 235 are depicted and described herein for exemplary purposes, and that in various embodiments, any desired components can be controlled via an arrangement of one or more pneumatic lines.

Electro-pneumatic regulators 215 are also controlled by pneumatic lines, which are selectively actuated to provide pilot fluids to pilot regulators 210 via pilot lines 211 (with the pilot fluids controlling operations of pilot regulators 210). In the depicted embodiment, there are two pilot lines 211, with one providing a shield pilot fluid (e.g., to the regulator 210 connected to only shield fluid line 250) and the other providing a plasma pilot fluid (e.g., to the regulator 210 downstream of valve 209).

Gas system 201 may also include a water mist secondary system. In the depicted embodiment, water is provided via water flow controller 257; a flow rate sensor 240 is provided downline of water flow controller 257 to monitor the flow rate of water in water line 260. Water line 260 may provide water to valve 258, which can be pneumatically-controlled to selectively permit water to flow through water line 259 to pathway 270 in order to protect consumables at the torch end.

Regardless of whether the gas system includes any or all of the aforementioned components, the various gas lines that are disposed downstream of a valve executing the mixing techniques herein allow mixed gas to fully combine or integrate subsequent to the mixing. For example, when mixing is executed at manifold 205 and/or valve 206, the entire length of a fluid carrying cable (see, e.g., cable 30 of FIG. 1A) may be utilized to create a homogenous fluid mixture. That is, the distance between a power supply and the torch may enable homogenous mixing. By comparison, if valves 208, 209, and/or 258 execute the mixing techniques presented herein, sufficient space/distance must be provided between the valves and the torch (e.g., from these valves to regulator 210). But, in any instance, regulators 210 may serve to mitigate any undesired pressure effects that are caused by actuating a valve. For example, rapidly actuating a valve between various positions can cause pressure waves or surges in the fluid downline. Accordingly, regulators 210 may vent to atmosphere, thereby reducing an influence of pulsation pressure effects on a piercing or cutting operation.

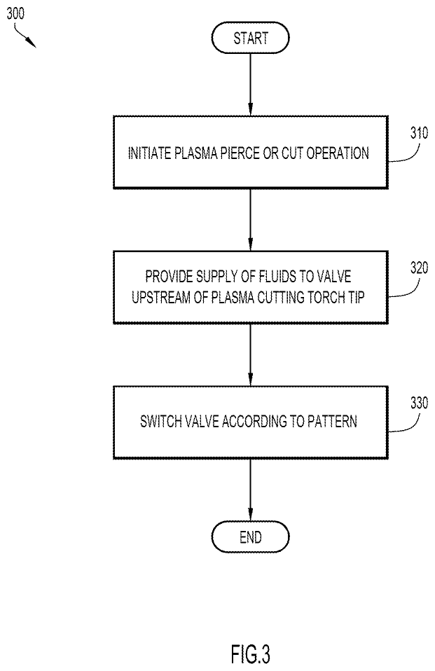

FIG. 3 is a flow chart depicting a method 300 of operating a plasma cutting torch, according to an example embodiment.

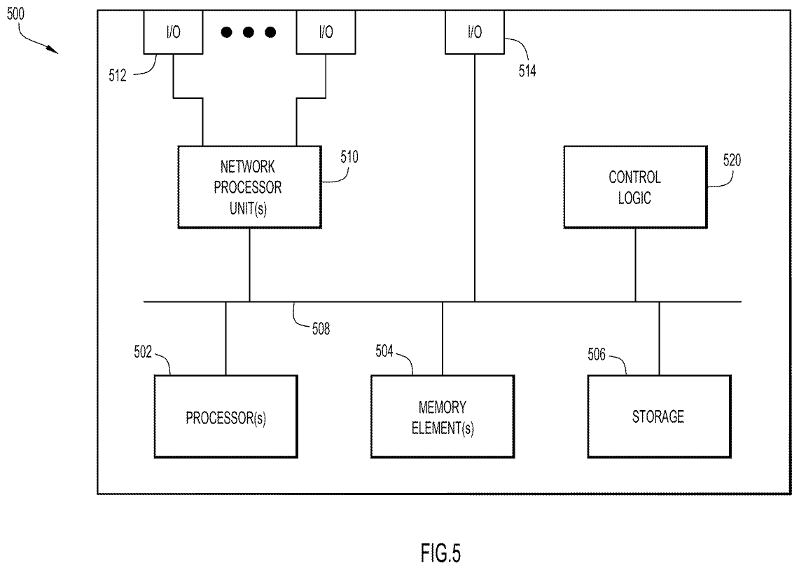

A plasma pierce or cut operation is initiated at operation 310. Initially, instructions for a piercing or cutting sequence are received by a plasma torch system (e.g., automated cutting system 10, plasma torch gas system 200 or 201, etc.). Instructions may be provided into a computing device (e.g., computing device 500, depicted and described in further detail with respect to FIG. 5) that controls operation of the plasma cutting system. The instructions may be entered by a user, retrieved from a local or network-accessible storage device, and the like, and may include any instructions that are executable to cause a plasma cutting system to perform a job, including pierce and cut operations. In particular, the instructions may indicate pierce and/or cut locations (with “cut” including marking operations for the purpose of this application), pierce and/or cut times, arc process parameters (e.g., fluid types and/or pressures for the shield fluid and/or plasma), plasma torch heights, any instructions to move a plasma torch relative to a workpiece during cutting and/or piercing operations, and the like. Additionally, the instructions may include a set of fluids to be provided to the plasma torch cutting system, including a volume of one or more fluids, a flow rate of one or more fluids, a pattern of switching valves to mix fluids in accordance with present embodiments, and any other instructions relating to the provisioning of fluids during a pierce or cut operation.

A supply of fluids is provided to a valve upstream of the plasma cutting torch tip at operation 320. Per the instructions provided at operation 310, fluids may be provided to a valve whose position is actuated according to a pattern to permit multiple fluids to mix in an outlet line in accordance with present embodiments. The valve may include a two-port, two-position valve, a three-port, two-position valve, a four-port, three-position valve, a shuttle valve, or other valve. The valve may be included in a gas selection manifold (e.g., gas select manifold 205 of plasma torch cutting gas system 200). Alternatively, the valve may be provided separate and independent from a gas selection manifold (e.g., valve 204 of gas system 200 and/or gas system 201). Either way, the valve may be electrically-actuated so that instructions provided by a computing device can control the valve. The fluids can include any desired fluid, such as a cutting fluid, a piercing fluid, a shield fluid, water, oxygen, and the like.

The valve is switched according to a pattern at operation 330. The valve can be switched between two or more positions to permit two or more fluids to pass through the valve and into an output line (e.g., fluid lines 241, 245, 255, and/or 250 of plasma torch gas system 200, depending on whether a valve in manifold 250 and/or valve 206 executes the mixing techniques). The pattern can be provided in the form of an electric signal that causes the valve to switch at defined intervals. In some embodiments, the pattern includes a cadence or periodicity over which the pattern regularly repeats (e.g., a pulse width modulation (PWM) over a predetermined amount of time). For example, a valve may occupy a first position for a first amount of time, a second position for a second amount of time, and a third position for a third amount of time, before returning to the first position to repeat the pattern. In some embodiments, the pattern itself may be adjusted during a particular cut or pierce sequence; in other words, multiple patterns may be employed during a particular session in which a plasma cutting torch is in operation. For example, a first pattern may toggle a valve between a first and second position according, and then, a second pattern may toggle the valve between a first and third position. Thus, toggling the valve provides multiple fluids to the line leading away from the valve, and as the fluids travel through the length of the output line, the fluids are able to achieve a substantially homogeneous mixture before arriving at the cutting torch tip.

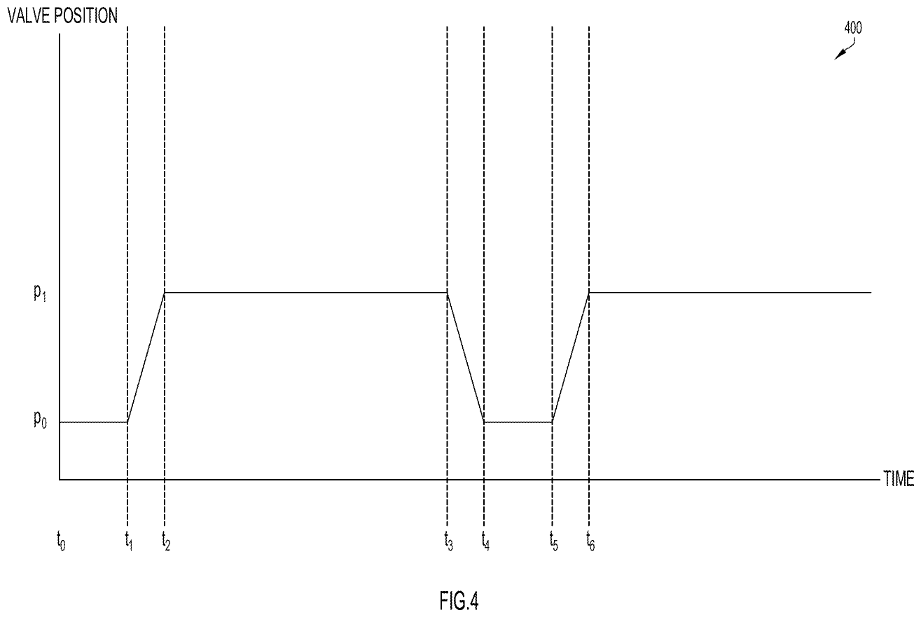

FIG. 4 is a graph 400 showing variations in valve parameters over time during a piercing and/or cutting operation. As depicted, there are two valve positions, p₀ and p₁, and the valve is switched between the positions according to a pattern that has a defined periodicity. Positions p₀ and p₁ may correspond to valve positions that permit a first fluid and a second fluid, respectively, to pass through the valve. Initially, at time to, the valve occupies position p₀. From time t₁ to t₂, the valve is actuated to the second position, p₁, whereupon the valve remains until time t₃. From time t₃ to t₄, the valve returns to the first position p₀, thus completing the pattern depicted in graph 400. To repeat the pattern again, the valve transitions to position p₁ from time t₅ to t₆. Accordingly, the pattern that is depicted in graph 400 has a period that repeats over a duration of time that spans from t₀ to t₄, with the pattern repeating again after time t₄. In various embodiments, the pattern may repeat for a predetermined amount of time, or the pattern may stop or transition to a new pattern after a certain duration of cutting or piercing. Additionally, in other embodiments, the transitions (e.g., from t₁ to t₂, from t₃ to t₄, etc.) may be shorter or longer, including instantaneous so that the graph would resemble a square step function. It should also be appreciated that a valve may have three or more positions, and in some embodiments, the pattern may be adjusted on-the-fly during a pierce or cut operation based on user input or other parameters (e.g., progression of the pierce or cut operation, thickness of the workpiece, etc.).

Now turning to FIG. 5, this Figure illustrates a hardware block diagram of a computing device 500 that may execute the techniques presented herein. This computing device 500 may be included in or formed from portions of any combination of parts included in the controller 16, the automated plasma arc torch 18, the power supply 14, and/or the positioning system 12 of an automated cutting system 10. Thus, any of the controller 16, the automated plasma arc torch 18, the power supply 14, and/or the positioning system 12 of an automated cutting system 10 may execute the techniques presented herein, alone or in combination with one or more other systems/components.

As depicted, the computing device 500 includes a bus 508, which provides communications between computer processor(s) 502, one or more memory elements 504, persistent storage 506, one or more network processor units 510 (i.e., a communications unit), and input/output (I/O) interface(s) 514. Bus 508 can be implemented with any architecture designed for passing data and/or control information between processors (such as microprocessors, communications and network processors, etc.), system memory, peripheral devices, and any other hardware components within a system. For example, bus 508 can be implemented with one or more buses.

Memory 506 and/or memory element 504 may include random access memory (RAM) or other dynamic storage devices (i.e., dynamic RAM (DRAM), static RAM (SRAM), and synchronous DRAM (SD RAM)), for storing information and instructions to be executed by processor 502. The memory 506 and/or memory element 504 may also include a read only memory (ROM) or other static storage device (i.e., programmable ROM (PROM), erasable PROM (EPROM), and electrically erasable PROM (EEPROM)) for storing static information and instructions for the processor 502. Additionally, although “control logic” 520 is illustrated separately from memory 506 and/or memory element 504, the control logic 520 may be stored as non-transitory computer readable instructions in memory 506 and/or memory element 504, for execution by processor 502 so that processor 502 can execute the techniques presented herein.

Although FIG. 5 shows the processor 502 as a single box, it should be understood that the processor 502 may represent a plurality of processing cores, each of which can perform separate processing. The processor 502 may also include special purpose logic devices (i.e., application specific integrated circuits (ASICs)) or configurable logic devices (i.e., simple programmable logic devices (SPLDs), complex programmable logic devices (CPLDs), and field programmable gate arrays (FPGAs)), that, in addition to microprocessors and digital signal processors may individually, or collectively, are types of processing circuitry.

The processor 502 performs a portion or all of the processing steps required to execute the techniques presented herein, e.g., in response to instructions received at network processor unit(s) 510 and/or instructions contained in memory 504 and/or memory 506. Such instructions may be read into memory 504 and/or memory 506 from another computer readable medium. One or more processors in a multi-processing arrangement may also be employed to execute the sequences of instructions contained in memory 504 and/or memory 506. In alternative embodiments, hard-wired circuitry may be used in place of or in combination with software instructions. Thus, embodiments are not limited to any specific combination of hardware circuitry and software. Put another way, the computing device 500 includes at least one computer readable medium or memory for holding instructions programmed according to the embodiments presented, for containing data structures, tables, records, or other data described that might be required to execute the techniques presented herein.

Still referring to FIG. 5, the network processor unit(s) 510 provides a two-way data communication coupling to a network, such as a local area network (LAN) or the Internet. The two-way data communication coupling provided by the network processor unit(s) 510 can be wired (e.g., via I/O interface(s) 512) or wireless. Meanwhile, I/O interface(s) 514 may allow for input and output of data with other devices that may be connected to computer device 500. For example, I/O interface 514 may provide a connection to external devices such as a keyboard, keypad, a touch screen, and/or some other suitable input device. External devices can also include portable computer readable storage media such as database systems, thumb drives, portable optical or magnetic disks, and memory cards.

While this application has described the techniques presented herein in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”. Finally, for the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. A method of operating a plasma cutting torch, the method comprising:
providing a plasma cutting torch tip at a distance from a workpiece to initiate a piercing or cutting operation;
providing a supply of a first fluid and a second fluid to a valve upstream of the plasma cutting torch tip, wherein the valve is joined to the plasma cutting torch tip by a fluid line; and
during the piercing or cutting operation, switching the valve according to a first pattern to provide a mixture of the first fluid and the second fluid to the plasma cutting torch tip.

2. The method of claim 1, wherein the mixture is provided based on one or more of: a length of the fluid line, a path of the fluid line, and an interior friction parameter of the fluid line.

3. The method of claim 1, wherein an additional one or more fluids are provided to the valve, and wherein switching the valve according to the pattern further includes providing a mixture of the first fluid, the second fluid, and the additional one or more fluids to the plasma cutting torch tip.

4. The method of claim 1, wherein the first fluid or the second fluid is selected from a group of: a cutting fluid, a shield fluid, water, and oxygen.

5. The method of claim 1, wherein the first pattern includes a periodicity of one second or less.

6. The method of claim 1, further comprising transitioning to a second pattern during the piercing or cutting operation, wherein the valve is switched differently according to the second pattern than according to the first pattern.

7. The method of claim 1, wherein a pilot pressure regulator is provided between the valve and an outlet of the plasma cutting torch tip to reduce an influence of pulsation pressure effects on the piercing or cutting operation.

8. The method of claim 1, wherein the valve is selected from a group of: a two-port, two-position valve, a three-port, two-position valve, a four-port, three-position valve, and a shuttle valve.

9. The method of claim 1, wherein the valve is electrically-actuated.

10. An apparatus comprising:
one or more computer processors;
one or more computer readable storage media; and
program instructions stored on the one or more computer readable storage media for execution by at least one of the one or more computer processors, the program instructions comprising instructions to:
provide a plasma cutting torch tip at a distance from a workpiece to initiate a piercing or cutting operation;
provide a supply of a first fluid and a second fluid to a valve upstream of the plasma cutting torch tip, wherein the valve is joined to the plasma cutting torch tip by a fluid line; and
during the piercing or cutting operation, switch the valve according to a first pattern to provide a mixture of the first fluid and the second fluid to the plasma cutting torch tip.

11. The apparatus of claim 10, wherein the mixture is provided based on one or more of: a length of the fluid line, a path of the fluid line, and an interior friction parameter of the fluid line.

12. The apparatus of claim 10, wherein an additional one or more fluids are provided to the valve, and wherein switching the valve according to the pattern further includes providing a mixture of the first fluid, the second fluid, and the additional one or more fluids to the plasma cutting torch tip.

13. The apparatus of claim 10, wherein the first fluid or the second fluid is selected from a group of: a cutting fluid, a shield fluid, water, and oxygen.

14. The apparatus of claim 10, wherein the first pattern includes a periodicity of one second or less.

15. The apparatus of claim 10, further comprising instructions to transition to a second pattern during the piercing or cutting operation, wherein the valve is switched differently according to the second pattern than according to the first pattern.

16. The apparatus of claim 10, wherein a pilot pressure regulator is provided between the valve and an outlet of the plasma cutting torch tip to reduce an influence of pulsation pressure effects on the piercing or cutting operation.

17. The apparatus of claim 10, wherein the valve is selected from a group of: a two-port, two-position valve, a three-port, two-position valve, a four-port, three-position valve, and a shuttle valve.

18. An apparatus comprising:
a plasma cutting torch tip;
a valve that receives a first fluid input and a second fluid input;
a common line, wherein the common line receives output from the valve and connects the valve to the plasma cutting torch tip; and
a controller configured to actuate the valve between a first position and a second position, wherein the first fluid input and the second fluid input provide a first fluid and second fluid, respectively, while the valve is actuated.

19. The apparatus of claim 18, wherein the controller provides an electric signal to cause the valve to be actuated according to a pattern.

20. The apparatus of claim 18, wherein the valve is actuated according to a pattern that causes the first fluid and the second fluid to be mixed in the common line based on one or more of: a length of the common line, a path of the common line, and an interior friction parameter of the common line.
